(19) United States
(12) Patent Application Publication
(10) Pub. No.: US 2025/0079077 A1
(43) Pub. Date: Mar. 6, 2025

(54) SUPERCONDUCTING MAGNET COIL MANUFACTURE

(71) Applicant: Tokamak Energy Ltd, Abingdon (GB)

(72) Inventors: Bas van Nugteren, Abingdon (GB); Shuvay Singh, Abingdon (GB)

(21) Appl. No.: 18/820,844

(22) Filed: Aug. 30, 2024

(30) Foreign Application Priority Data
Aug. 31, 2023 (GB) 2313288.9
Aug. 31, 2023 (GB) 2313294.7

(51) Int. Cl. H01F 41/04; H01F 41/064

(52) U.S. Cl. CPC H01F 41/048; H01F 41/064

(57) ABSTRACT

A method for manufacturing a superconducting magnet comprising: providing an electrically conductive substrate (such as an open U-channel) shaped into a substantially planar coil having a plurality of turns, the electrically conductive substrate having a groove along its length, the groove facing a radial direction of the coil or, in other words, the groove facing either inwardly or outwardly in the plane of the coil; translating at least a portion of the electrically conductive substrate out of the plane of the coil to expose at least a portion of the groove; and inserting superconducting material into the exposed portion of the groove.

### CROSS-REFERENCE TO RELATED APPLICATIONS

The present application is based upon and claims the right of priority to GB Patent Application No. 2313288.9, filed Aug. 31, 2023, and to GB Patent Application No. 2313294.7, filed Aug. 31, 2023, the disclosures of which are hereby incorporated by reference herein in their entirety for all purposes.

### TECHNICAL FIELD

The present invention relates to the manufacture of superconducting magnetic field coils.

### BACKGROUND

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a peak critical temperature (the temperature above which the material cannot be superconducting, even in zero magnetic field) below 30 K. The behaviour of HTS materials is not described by BCS theory, and many have critical temperatures well above 30 K. The most commonly used HTS materials are “cuprate superconductors”-ceramics based on cuprates (compounds containing a copper oxide group), such as BSCCO, or ReBCO (where Re is a rare earth element, commonly Y or Gd). Other HTS materials include iron pnictides (e.g. FeAs and FeSe) and magnesium diboride (MgB₂).

ReBCO superconductors are typically manufactured as tapes approximately 100 micrometres thick and with a width of between 2 mm and 12 mm. The structure of a typical tape 100 is illustrated in FIG. 1 and includes a substrate 101, typically an electropolished nickel-molybdenum alloy, e.g., Hastelloy®, approximately 50 micrometres thick, on which is deposited a series of buffer layers known as the buffer stack 102, of approximate thickness 0.2 micrometres. An epitaxial ReBCO-HTS layer 103 overlays the buffer stack, and is typically 1 micrometre thick. A 1-2 micrometre silver layer 104 and a copper stabilizer layer 105 are deposited on and often completely encapsulate the tape. The silver layer 104 and copper stabilizer layer 105 extend continuously around the perimeter of the tape 100 (not illustrated in FIG. 1 for clarity) and may therefore also be referred to as “cladding”. The silver layer 104 makes a low resistivity electrical interface to, and an hermetic protective seal around, the ReBCO layer 103, whilst the copper layer 105 enables external connections to be made to the tape (e.g. by soldering) from either face and provides a parallel conductive path for electrical stabilization. “Exfoliated” HTS tape can also be manufactured, which lacks a substrate and buffer stack.

An HTS cable comprises one or more HTS tapes which are connected along their length by conductive material such as a solder. The HTS tapes may be stacked (i.e. arranged such that the HTS layers are parallel), or there be some other arrangement of tapes, which may vary along the length of the cable. Tapes or layers of other materials may be provided between some or all of the HTS tapes to provide desired mechanical and electrical properties to the cable.

A superconducting magnet is formed by arranging HTS cables into coils comprising one or more turns. A turn or winding of a coil is a section of HTS cable which encloses the inside of the coil (i.e. which can be modelled as a complete loop). The HTS cable can form a continuous spiral. One type of coil is a pancake coil, where HTS cables are wound in a planar spiral to form a flat coil. Circular, racetrack or D-shaped coils may be made, but, in general, the coil can have inner and outer perimeters which are any 2-dimensional shape. The turns can be insulated from one another by providing electrically insulating material between them such that current can only flow in the spiral path along the cable. Alternatively, the turns can also be electrically connected radially, resulting in a non-insulated or partially insulated coil.

One use of HTS field coils is in tokamak plasma chambers, including spherical tokamaks, where strong magnetic fields are required to confine and control plasma. HTS field coils are also used in other magnetic plasma confinement devices, such as stellarators. Many other applications are possible, including magnets for electric motors or generators, nuclear magnetic resonance (NMR) or magnetic resonance imaging (MRI) devices, or in proton beam therapy (PBT) and proton boron capture therapy (PBCT) devices.

In a superconducting magnet coil, the maximum current density that can be carried by the superconductor material, the critical current density Jc, depends on both the magnetic field and temperature. If the critical current density is exceeded locally the material starts to transition to normal conductivity. When this happens, ohmic heating causes the temperature to rise rapidly resulting in a total loss of superconductivity. This phenomenon is called a quench. When a quench occurs in a superconducting magnet it is necessary to detect it and take corrective action, such as extracting or otherwise safely dumping the electrical energy of the coil, before the hotspot temperature damages the coil.

One way to increase the time available to detect and respond to a quench is to increase the fraction of electrical stabilizer material in the cable. This increases the heat capacity and reduces the electrical resistance of the non-superconducting fraction of the cable, allowing the electrical current to bypass the normal zone for a longer duration before the coil is damaged. One technique for adding more stabilizer is to form a cable comprising a metal substrate having HTS tapes electrically connected to the metal substrate. WO2023/083667, for example, describes an HTS cable in which the substrate comprises a conductive (e.g., copper) channel having a stack of HTS tapes laid within a groove of the channel and secured with a bonding agent (e.g., a solder). Other techniques include, without limitation, using HTS tapes with a thicker copper stabiliser layer 105, and/or interleaving the HTS tapes with electrically conductive tapes of, e.g., copper.

The manufacture and winding of such a cable into a magnetic coil is not a trivial task. For toroidal field magnets in a tokamak, for example, it may be necessary to stack on the order of 10 to 100 HTS tapes within the groove to obtain the required current carrying characteristics. The cable will typically be consolidated by filling the groove with a consolidating material such as a solder or resin that secures the tapes to the substrate and penetrates the spaces between the tapes to improve mechanical strength and electrical conductance. Subsequent bending of a consolidated cable would place significant strain on the HTS tapes at the outside of the bend, reducing the achievable critical current density or causing other mechanical and electrical problems.

WO2023/083956 describes a winding method for a magnetic field coil where partially overlapping HTS tapes are laid on a substrate to create each turn of the coil. By continually laying down additional channel and tapes, the coil can be built up to any desired number of turns. A spool travels around the coil laying out the substrate and an apparatus for laying the tapes travels around the path of the coil, spooling out tape and applying a fixing medium (e.g., solder) from a dispenser, to lay each tape in turn.

One problem with this approach is that the steps of bending the channel and inserting and fixing the HTS tapes are all performed simultaneously. An improved approach where steps can be separated if desired would enable easier inspection and the correction of problems.

In the construction of toroidal field coils for the International Thermonuclear Experimental Reactor (ITER) a cylindrical low temperature superconducting cable was bent into a coil shape and the turns were then lifted to wrap a layer of insulation around the cable.

### SUMMARY OF THE INVENTION

A first aspect of the present invention provides a method for manufacturing a superconducting magnet comprising: providing an electrically conductive substrate (such as an open U-channel) shaped into a substantially planar coil having a plurality of turns, the electrically conductive substrate having a groove along its length, the groove facing a radial direction of the coil or, in other words, the groove facing either inwardly or outwardly in the plane of the coil; translating at least a portion of the electrically conductive substrate out of the plane of the coil to expose at least a portion of the groove; and inserting superconducting material into the exposed portion of the groove.

Embodiments of the present invention enable the manufacture of a pancake coil from an untwisted superconducting cable where superconducting material is inserted into a radially facing groove of a pre-bent conductive channel in a separate step and without placing strain on the superconducting material by bending a consolidated cable. The superconducting material may be a plurality of tapes of high temperature superconducting material arranged in a stack and aligned with each other along the length of the wound coil.

In one embodiment, the translating step comprises progressively, along the length of the electrically conductive substrate, translating a portion of the electrically conductive substrate out of the plane of the coil to progressively expose a portion of the groove. For example, a portion of the coil may be raised, then lowered once the superconducting material is inserted into the exposed groove, or supported in an elevated plane with an exposed portion in between the two planes. In another arrangement, substantially the whole coil may be translated out of the plane of the coil to form a spiral helix, with substantially the whole groove being exposed simultaneously.

In one embodiment, the superconducting material is consolidated in the groove with an electrically conductive consolidating material such as a solder. For example, a part of the exposed portion of the groove may be substantially filled with liquid consolidating material which solidifies to consolidate the cable. This may be achieved by submerging at least the exposed portion of the groove, or the whole channel, in liquid consolidating material. The liquid consolidating material may be contained in a mobile bath which is moved along the length of the coil to progressively submerge an exposed portion of the groove of the electrically conductive substrate.

In one embodiment, the method further comprises bending the electrically conductive substrate to provide the substantially planar coil. This bending step may be performed independently from the insertion step, or as part of a connected process.

In another aspect, the present invention provides a method for manufacturing a superconducting magnet comprising: providing an electrically conductive substrate shaped into a substantially planar coil having a plurality of turns, the electrically conductive substrate having a groove along its length, the groove facing a radial direction of the coil, superconducting material being located within the groove; translating at least a portion of the electrically conductive substrate out of the plane of the coil to expose at least a portion of the groove; and consolidating the superconducting material located in the exposed portion of the groove. In this aspect, the consolidating step is performed after the insertion step using a similar process of translating a portion of the coil to expose the groove. Advantages and preferred features of this aspect will be apparent from the discussion of the first aspect and the detailed description below.

In another aspect, the present invention provides a device for manufacturing a superconducting magnet comprising: a substantially planar coil having a plurality of turns formed from an electrically conductive substrate, the electrically conductive substrate having a groove along its length, the groove facing a radial direction of the coil; a first carriage (or at least one first carriage) movable relative to the coil and for translating at least a portion of the electrically conductive substrate out of the plane of the coil to expose at least a portion of the groove; and at least one of: a second carriage movable relative to the coil and for inserting superconducting material into the exposed portion of the groove; and/or a third carriage movable relative to the coil and for consolidating superconducting material located in the exposed portion of the groove. Advantages and preferred features of this aspect will be apparent from the discussion of the first aspect and the detailed description below.

In another aspect, the present invention provides a method for manufacturing a superconducting magnet comprising: providing a substrate shaped into a spiral coil having a plurality of turns, each turn being larger in a radial direction of the coil than a preceding turn; translating at least a portion of the substrate in a direction substantially perpendicular to said radial direction to make the portion of the substrate accessible for a subsequent operation; at the accessible portion of the substrate, performing one or both of the following subsequent operations: applying superconducting material to the substrate; and fixing superconducting material to the substrate.

In another aspect, the present invention provides a device for manufacturing a superconducting magnet comprising: a support configured to hold a coil having a plurality of turns formed from an electrically conductive substrate; one or more first carriages movable relative to the support and for translating at least a portion of the electrically conductive substrate away from the support to expose at least a portion of a radially inward facing or radially outward facing surface of the substrate; and at least one of: a second carriage movable relative to the support and for applying superconducting material to the exposed radially inward facing or radially outward facing surface of the substrate; and/or a third carriage movable relative to the support and for consolidating superconducting material located on the exposed radially inward facing or radially outward facing surface of the substrate.

In another aspect, the present invention provides a bath for consolidating a superconducting cable, the bath comprising: a container having first and second openings in respective sides of the container, the first opening being located on an opposite side of the container to the second opening; first and second seals positioned respectively within the first and second openings, the first and second seals each having an aperture through the respective seal and each seal being flexible and resilient to conform to the superconducting cable when the superconducting cable passes though the respective aperture; wherein the container is configured to contain an amount of liquid consolidating material that at least partially submerges a superconducting cable passing through both apertures. Baths embodying this aspect of the invention may be used in connection with the preceding aspects or may find utility in other situations.

Advantageously, baths embodying this aspect can be used to consolidate a pre-bent, substantially rigid superconducting cable.

In one embodiment, the bath further comprises an elongate sleeve extending from an the aperture of the second seal, and joined with a seal to reduce or prevent leakage, the sleeve formed from a flexible and resilient material for sealing around the superconducting cable.

In one embodiment, means for cooling the sleeve are provided such that, in use, the liquid consolidating material solidifies before the cable exits the sleeve.

In one embodiment, an internal wall within the sleeve is provided with a groove in fluid communication with the container and providing a passage for the flow of consolidating material from the container along the sleeve. This enables additional consolidating material to flow into the superconducting cable and ensure the cable is substantially filled with consolidating material.

In one embodiment, the bath further comprises a displacer movable relative to the container to different positions within the container. In this way a level of liquid consolidating material within the container can be raised and lowered to selectively submerge the superconducting cable.

In one embodiment, each opening comprises an open slit in a top edge of the container. This enables easy access for inserting and replacing seals into the openings, and for initially introducing the superconducting cable into the bath.

In another aspect, the present invention provides a method of consolidating a superconducting cable, the method comprising: providing a container having first and second seals in different sides of the container, the first and second seals each having an aperture through the respective seal, and each seal being flexible and resilient to conform to the superconducting cable when the superconducting cable passes through the aperture; inserting a portion of the superconducting cable into the container such that the superconducting cable passes through the first and second apertures; providing a consolidating material as a liquid within the container at a level which at least partially submerges the portion of the superconducting cable; moving the superconducting cable and the container relative to each other to pass the superconducting cable through the apertures and thereby at least partially submerge progressive portions of the superconducting cable in the consolidating material as a liquid; allowing the consolidating material to solidify within the superconducting cable to consolidate the superconducting cable.

In another aspect, the present invention provides a method of consolidating a superconducting cable, the method comprising: providing a sleeve, wherein the sleeve is a flexible, resilient sleeve having an internal surface which conforms to the superconducting cable; passing the superconducting cable through the sleeve; providing consolidating material as a liquid to the superconducting cable as the superconducting cable enters the sleeve or prior to the superconducting cable entering the sleeve; wherein the superconducting cable passes through the sleeve at a rate such that the consolidating material is substantially solid where the superconducting cable exits the sleeve. Embodiments of this aspect provide several options for manufacturing and consolidating a superconducting cable. For example, the sleeve may be connected to the exit from a bath (such as the bath described above) containing liquid consolidating material and the method further comprises at least partially submerging the superconducting cable (which may be a substantially rigid and/or pre-bent cable) in liquid consolidating material within the bath and passing the superconducting cable through the bath. The superconducting cable may comprise superconducting material located within a groove of a conductive channel in this case.

In another arrangement, the method further comprises bending the cable as it passes through the sleeve before the liquid consolidation material has solidified. In this arrangement, the cable may be a stack of tapes of high temperature superconducting (HTS) material (and optionally additional layers or tapes of different materials) than can be bent while inside the flexible sleeve and while the consolidation material is still liquid to avoid placing strain on the HTS material by bending a consolidated cable.

In another aspect, the present invention provides apparatus for consolidating a superconducting cable, the apparatus comprising: a sleeve, wherein the sleeve is flexible and resilient to conform to the superconducting cable, the sleeve having a first end and a second end; a liquid consolidating material supply located at the first end of the sleeve and configured to supply liquid consolidating material to the superconducting cable.

Further embodiments of the above aspects are provided in claim 2 et seq and in the clauses at the end of the description.

### BRIEF DESCRIPTION OF THE DRAWINGS

Preferred embodiments of the present invention will now be described by way of example only and with reference to the following drawings, in which:

FIG. 1 illustrates a high temperature superconducting tape;

FIGS. 2A and 2B illustrate a cable comprising an open conductive channel;

FIG. 3 illustrates a planar coil wound from such a cable;

FIG. 4 illustrates a helical spiral;

FIG. 5 illustrates a device for elevating a wound planar coil into a helical spiral;

FIG. 6 illustrates a device for progressively elevating a wound planar coil;

FIG. 7 illustrates a bath for containing consolidation material;

FIG. 8 illustrates a cable within a flexible sleeve; and

FIG. 9 illustrates an apparatus for consolidating a superconducting cable.

### DETAILED DESCRIPTION OF PREFERRED EMBODIMENTS

FIGS. 2A and 2B illustrate an HTS cable 200 as described in WO2023/083956 and WO2023/083667. FIG. 2A is an isometric view, and FIG. 2B is an end-on cross section. Only a short section of the HTS cable is shown, and it may extend for any length in the directions indicated by the arrows in FIG. 2A.

FIG. 2A also shows three directional axes which will be used in the subsequent description—i.e. L is “along the length” of the HTS cable, W is “along the width” of the HTS cable, and H is “along the height” of the HTS cable. Where the HTS cable is curved or twisted, each of these axes is considered locally such that the orientation of the axes is relative to the HTS cable at the point being discussed, rather than being relative to some external reference. For example, when the HTS cable is wound into a coil, the direction H may be the radial direction of the coil.

The HTS cable 200 comprises a channel 201, the channel providing a substrate to the HTS cable. The channel 201 is an elongate conductive element having a groove 202 in one side along its length such that it has a substantially flattened U-shaped cross section.

In other words, the channel 201 has a web that extends in the width direction W, the web connecting two flanges that extend in the height direction H, with the space between the flanges defining the groove 202 that extends in the length direction L. This arrangement, with an open U-channel structure for the substrate, will be described in the below for ease of understanding, but it will be appreciated that other arrangements are possible. For example, the conductive element may have a second groove on an opposite side from the first groove such that it has a substantially H-shaped cross section. This arrangement is equivalent to two U-shaped channels fixed back-to-back with little or no electrical or thermal resistance between them. In either a U- or H-channel, the flanges advantageously provide good electrical stabilisation to the full height of the HTS cable 200. Nevertheless, a substantially flat substrate, without flanges, is also possible. Any required electrical stabilisation at the sides of the cable may be provided by some other mechanism such as leaving a space which is subsequently filled with a conductive material such as a solder.

The channel 201 may be formed from any electrically conductive material such as copper or aluminium electroplated with copper to assist with soldering. Other suitable materials include metals and metal alloys such as high copper alloys having greater strength than pure copper, brass, stainless steel, or a conductive composite or ceramic material, or a combination of these. Different materials may be used in different regions of the channel to achieve desired mechanical, electrical and thermal properties.

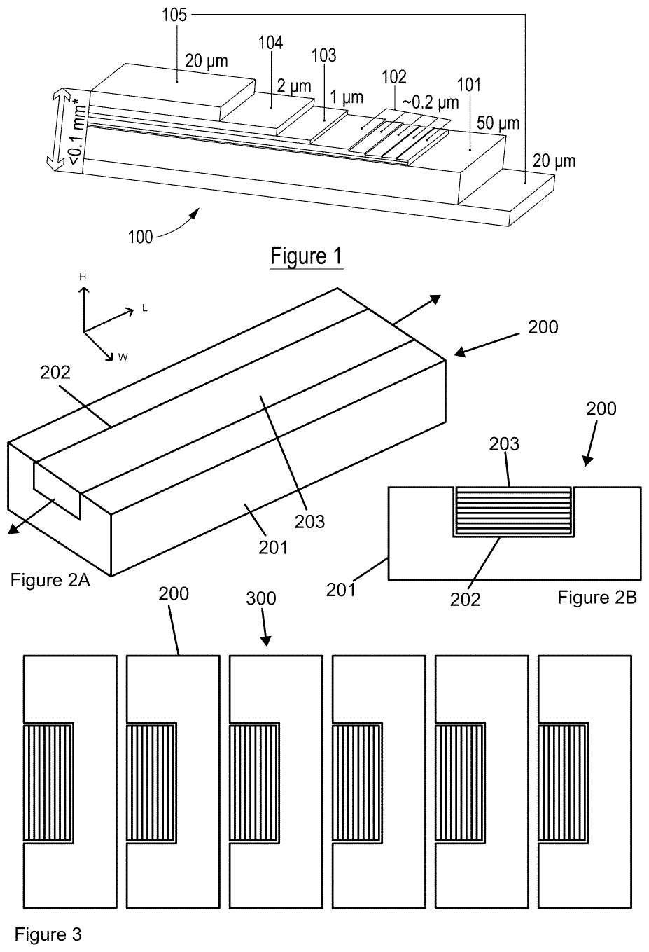

HTS material is located within the groove 202. The HTS material may be HTS tapes 203 as described above with reference to FIG. 1. The HTS tapes 203 may be arranged as a stack, as illustrated in FIG. 2B, or in some other arrangement. When stacked, the HTS tapes 203 are substantially parallel with each other along their length, with their width substantially parallel to the width W of the channel 201, and stacked in a direction substantially parallel to the height H of the channel 201. The stack may include other materials, such as copper tapes interleaved with the HTS tapes 203, to obtain desired electrical, thermal and mechanical properties.

In FIGS. 2A and 2B, the channel 201 has a substantially rectangular convex envelope. The envelope may be 10 mm to 30 mm wide and 4 mm to 15 mm high, for example, though the exact size and shape will depend upon the desired electrical, thermal and mechanical properties of the cable. Similarly, the groove 202 is substantially rectangular to receive a stack of HTS tapes. The width of the groove may be from 2 mm to 12 mm to accommodate the typical widths of HTS tapes, and between 1 mm and 10 mm deep depending on the number of HTS tapes required to, for example, achieve a desired current density. To secure the HTS material within the channel, a conductive bonding agent may be used such as a solder, a resin impregnated with conductive material, or similar. The number and/or width of the tapes in the channel can vary along the length of the cable to make a graded coil having varying current density. The size and shape of the groove 202 can vary accordingly along its length and/or the excess space filled with the bonding agent or other fillers or packing. After locating and/or consolidating the HTS tapes 203 within the groove 202, the channel 201 may be closed, with a metal (e.g., copper) lid for example, or it may be left open.

The conductive material of the channel 201 provides a low resistance alternative current path for current sharing between the HTS tapes of the cable 200, and between turns if the coil is non-insulated or partially insulated. Additionally, the channel provides a significant thermal mass in close thermal contact with the HTS, which will help to mitigate any heating caused by HTS material becoming resistive in the event of a quench.

A cross section through a coil 300 wound from the cable 200 is shown in FIG. 3. The illustrated coil 300 is a pancake or substantially planar coil with the turns winding spirally without twisting of the cable 200 such that the groove 202 in the channel 201 faces the radial direction of the coil 300, i.e. the direction H of the cable 200 is substantially aligned with the radial direction of the coil. This means that at each point in the coil, the plane of each HTS tape 203 stacked in the groove 202 (i.e. the plane defined by the L and W directions) is substantially aligned with the magnetic field generated during operation of the coil. This provides a preferential orientation for maximising critical current density compared to twisted arrangements where the plane of each HTS tape has a significant component perpendicular to the magnetic field along most of its length.

The groove 202 may face inwardly, towards the centre or interior of the coil, or outwardly (i.e. the groove may face either way along the direction H). This may be referred to as concave winding where the groove faces inwards, or convex winding where the groove faces outwards. Each of these options has advantages, disadvantages and associated engineering challenges. With convex winding, the HTS tapes 203 may be held within the groove by applying tension to the HTS tapes 203 during winding, prior to fixing them or consolidating the stack. During operation of a concave wound magnet, forces resulting from the magnetic field will push the HTS tapes 203 into the groove 202, reducing the risk of peeling of the HTS tapes 203. If wound in the convex way, the risk of peeling of the HTS tapes 203 may be mitigated by providing a “lid” or other structural support covering the stack in the groove. In the subsequent description and Figures, a concave winding approach is illustrated, but it will be recognised that either approach may be used in practice.

As discussed above, bending and winding a cable 200 in which a stack of HTS tapes 203 has already been fixed and/or consolidated within the groove 202 can cause excessive strain on the HTS tapes 203, degrading their performance. The winding process described in WO2023/083956 addresses this problem, but performing all the steps of bending the channel 201 and inserting and consolidating the HTS tapes 203 simultaneously is complex.

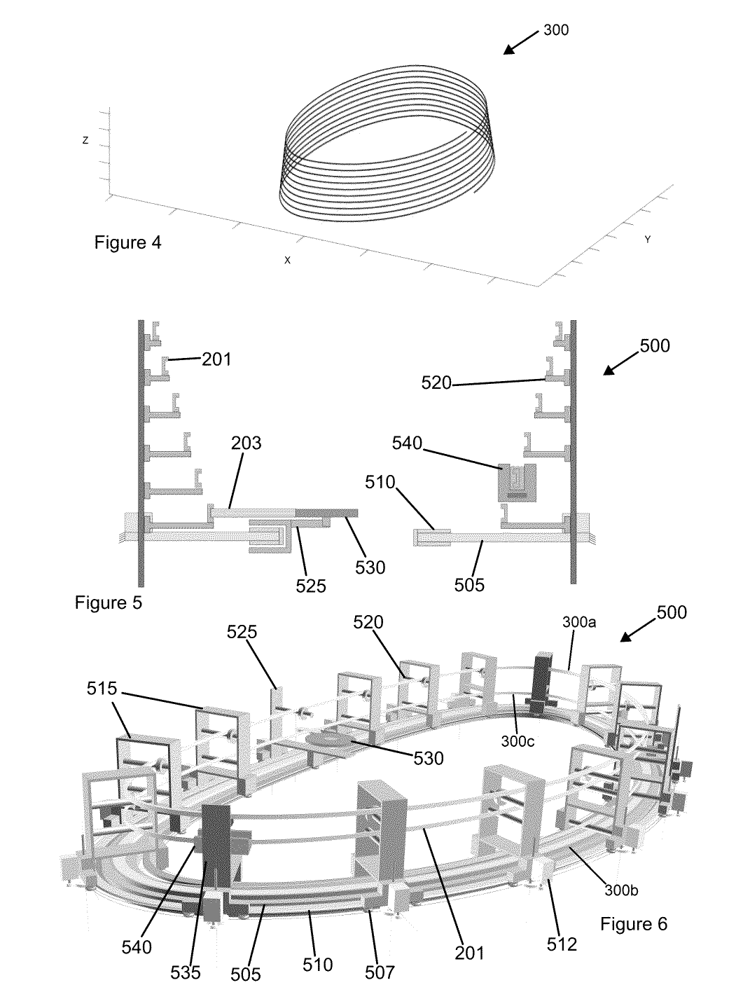

Embodiments of the present invention propose an alternative manufacturing process in which the channel 201 is first bent and wound into the desired coil shape, e.g., a substantially planar spiral. Then, by moving or translating one end of the channel 201 out of the plane of the spiral, the coil is opened up creating a helical spiral. This is illustrated in FIG. 4 in which the turns of a D-shaped coil 300 are opened up in a Z direction (e.g. vertically), out of an X-Y plane of the coil. In the example illustration of FIG. 4, all of the turns of the coil 300 are opened up in a continuously elevating helix. It will be appreciated from the below, however, that it is possible to translate and open up only portions of the coil (i.e. a subset of the turns of the coil) at a time.

This process makes at least portions of the individual turns of the coil accessible and also exposes the groove 202 in the channel 201 for subsequent manufacturing operations. A subsequent operation includes the insertion and/or fixing of the HTS tapes 203 around the full coil. Another subsequent operation is consolidating the HTS tapes 203 within the groove 202, i.e., substantially filling the groove and/or spaces between the HTS tapes with a consolidating material such as a solder. These subsequent operations may be performed simultaneously with each other, or the HTS tapes 203 may be temporarily held in place and consolidated in a separate step.

In this description, “the plane of the spiral” or “the plane of the coil” means a first plane (e.g. the X-Y plane in FIG. 4) in which the coil is initially wound. In particular, “the plane of the coil” is treated as substantially fixed through the manufacturing process, and does not move as parts of the coil (or even the entire coil) are translated out of that plane.

Translation of the channel 201 in the Z direction of the coil 300 does not require bending of the channel 201 about axes in the H or W directions of the channel, but only results in a twist about the L axis. Bending about the H axis (known as “hard way” bending) of the channel 201 and any HTS tapes 203 within the channel 201 could cause significant damage to the HTS tapes. Also, as discussed above, bending about the W axis of a consolidated or otherwise rigid stack of HTS tapes can cause damage to the tapes on the outside of the bend.

A coil manufacturing device 500 is illustrated schematically in cross-section in FIG. 5 and in perspective view in FIG. 6. The channel 201 is bent into the shape of the coil 300, e.g. a planar D-shaped coil. The coil 300 is placed on a fixed, horizontal table 505 orbited by mobile carriages or trains for performing different manufacturing processes. The carriages move around the table 505 on wheels 507 following a track or rails 510. Each carriage may be moved by an attached motor 512 for powering a round gear that engages with a rack gear, for example.

A first group of carriages comprise guide carriages 515. Each guide carriage 515 comprises one or more supports 520 such as rollers that lift the channel 201 vertically from the table 505 progressively along its length such that at least a portion of the radially facing groove 202 is exposed. In the illustration of FIG. 6, this separates the coil 300 into an upper planar coil portion 300a and a lower planar coil portion 300b with a helical portion 300c in between where the groove 202 is exposed and one or more individual turns are accessible. Alternatively, the supports 520 may be arranged such that after a sufficient number of rotations around the coil, the guide carriages 515 open substantially the whole coil 300 into a helix, as illustrated in FIGS. 4 and 5, exposing the groove 202 over substantially the full length of the channel 201. In yet another arrangement, a portion of the channel 201 is progressively lifted going around the coil, to expose the corresponding portion of groove 202, and then lowered back to the table 505. It will be noted that the reverse arrangements where the guide carriages 515 lower then raise the channel 201 from an elevated table 505 are possible, or the plane of the coil 300 may not be horizontal. The general principle is that some or all of the channel 201 is translated out of the plane of the coil 300 to make individual turns accessible and to expose the radially facing groove 202.

The supports 520 may be movable vertically in order to open the coil into a helix. In this case, the guide carriages 515 may be fixed in place relative to the table 505 and only the supports 520 move during the process. Alternatively, each guide carriage 515 has one or more supports 520 at a different fixed height and there are sufficient guide carriages 515 spaced around the track 510, each with one or more supports 520, to smoothly lift the channel 201 as the guide carriages 515 move around the track 510. This avoids the need to use additional motors for vertical adjustment of the supports 520. As illustrated in FIG. 6, each guide carriage 515 may include two or more supports 520. Multiple supports may allow multiple distances of translation of the channel from the plane to be supported by the same carriage. Also, each carriage may include an upper support positioned in the same horizontal plane as the upper support of each other carriage to support the upper planar coil portion 300a at the same height.

A second carriage or group of carriages comprises one or more tape laying carriages 525 for placing tape in the exposed groove 202. The or each tape laying carriage 525 includes one or more spools 530 of HTS tape 203. The tape laying carriage 525 may have only a single spool 530, as shown in FIG. 6, for continuously laying down a single HTS tape 203. This reduces complexity in tape laying, but increases the time and/or number of carriages required to lay down a stack of HTS tapes. The tape laying carriage 525 may instead have multiple spools 530 and/or other components for laying down one or more layers of HTS tape 203 either substantially continuously or in shorter, partially overlapping lengths using techniques such as those described in WO2023/083956. During one or more passes, each pass running the guide carriage 515 cycle from start to the end and optionally also in the reverse direction, a stack of HTS tapes 203 is laid within the groove 202 along the length of the channel 201. Flux is optionally added to the surface of each HTS tape and/or within the groove 202 to aid with subsequent consolidation by soldering. The flux may be a room temperature sticky flux that provides some adhesion to hold the HTS tapes in place until soldering. Alternatively, or in addition, rollers can be used to compact the tapes in the channel or other means employed for temporarily holding the tapes within the groove 202. As previously noted, in the case where a convex winding strategy is used (i.e. the tape is applied to a radially outward facing surface of the substrate), the winding may be done with tension, which will hold the HTS tapes against the substrate.

A third carriage or group of carriages comprises one or more fixing carriages 535 for carrying a tape fixing or consolidation device 540 such as a solder bath. One detailed embodiment of a solder bath will be described in more detail below. The tape consolidation device 540 applies solder or other suitable consolidation material to the HTS tapes 203 within the exposed groove 202 to substantially fill the groove and penetrate spaces between the tapes to ensure good electrical contact between the HTS tapes 203 and the conductive channel 201. The fixing carriage 535 may operate during the same pass as the tape laying carriage 525 (operating on regions of the coil where the tape laying carriage has previously laid tape), or during a final pass of the tape laying carriage 525, or during a separate pass once the tape has been laid and inspected for quality.

Following consolidation of the HTS tapes 203 within the groove 202, other processing steps may be performed to finish the coil, such as applying a layer of insulation around the cable 200, performing tightening and final alignment of the turns of the coil 300, and consolidating the coil 300 in resin or other suitable material. These may be performed by suitably configured carriages.

The channel 201 may be pre-bent on a separate device and placed on the manufacturing device 500. Alternatively, the manufacturing device 500 can also be used when bending the channel 201 prior to laying the tapes. An optional fourth carriage therefore comprises a channel bending carriage (not shown, though the principles will be clear from the above discussion of other types of carriages). A channel bending carriage may include any suitable bending device such as a roll bender, which bends the channel 201 without leaving any internal stresses. The channel 201 is fed into the bending device from a mandrel which also moves around with the channel bending carriage. The channel is bent by the bending device to the desired local curvature. For complex coil shapes, this curvature is not constant, requiring control (e.g. programmatic or computer control) of the bending device. The control may adjust the orientation and spacing of a roll bender according to the required curvature as the bending carriage moves along the track 510. After bending the channel 201 is guided down onto the winding table by one or more guide carriages 515. The channel bending carriage can then be removed in preparation for the HTS tape insertion and consolidation process described above.

Apart from the progressive lifting and lowering described above, the coil 300 is stationary during operation of the manufacturing device 500. Consequently, the manufacturing device 500 can be scaled to coils of any size and may be used with coils of any outline, including circular, racetrack or D-shaped coils. In general, while the overall radius of a spiral coil will increase from one turn to the next turn (i.e. for a given angular position around each turn, the radius or distance from a central point increases from one turn to the next), irregular spiral shapes in which the radius can either increase or decrease with distance around a single turn are possible and susceptible to the method and manufacturing device 500 described above. While this refers to the “next” turn as being radially outwards of the “previous” turn, the winding device 500 may be configured to operate in either direction, i.e. progressing radially inwards or outwards on the spiral.

The manufacturing device 500 can also be used with non-planar spiral coils where all the turns do not lie within a single plane but are at different heights (or different values of Z as illustrated in FIG. 4). For such coils, the table 505 of the manufacturing device 500 may be contoured with a variable height to trace the varying shape of the coil with radius. The principles described above still apply to non-planar coils where, for a defined X-Y plane and/or radial direction, the turns of the coil are translated in a direction substantially perpendicular to the radial direction (i.e., in the Z direction or vertically for a horizontal table 505) to make the turns of the coil accessible and ensure the groove is exposed for performing manufacturing operations as described above.

To fix and consolidate the stack of HTS tapes 203 laid within the channel 201, it has been discovered that applying flux to the individual tapes and/or to the inside of the groove 202 and then submerging the channel 201 (or at least the stack of HTS tapes 203 within the channel) in a solder results in a consolidated stack having good electrical connection between individual HTS tapes 201 and between the HTS tapes and the channel 201. For example, the channel 201 can be submerged in a tin-lead solder at approximately 210° C. for about 20 seconds. Although it may be possible to submerge the whole coil or large sections of the coil in solder in some circumstances, this will often not be practical for large coils or coils having a channel 201 or other substrate. Instead, sections of individual turns of the coil (e.g. exposed or accessible turns of the coil as described above) are submerged in a solder contained within a solder bath that is small compared to the coil. This may be done in a continuous process where turns of the coil are progressively passed through a solder bath (or the solder bath moves around the coil) such that each part of the coil spends at least the required time within the bath.

Solder baths are known from, for example, US2018/0226177 which describes a stack forming device in which a plurality of tapes enter a solder bath through comb-like inputs to individually wet each with solder, are combined in a passage, and exit the solder bath through a spring-loaded sliding door.

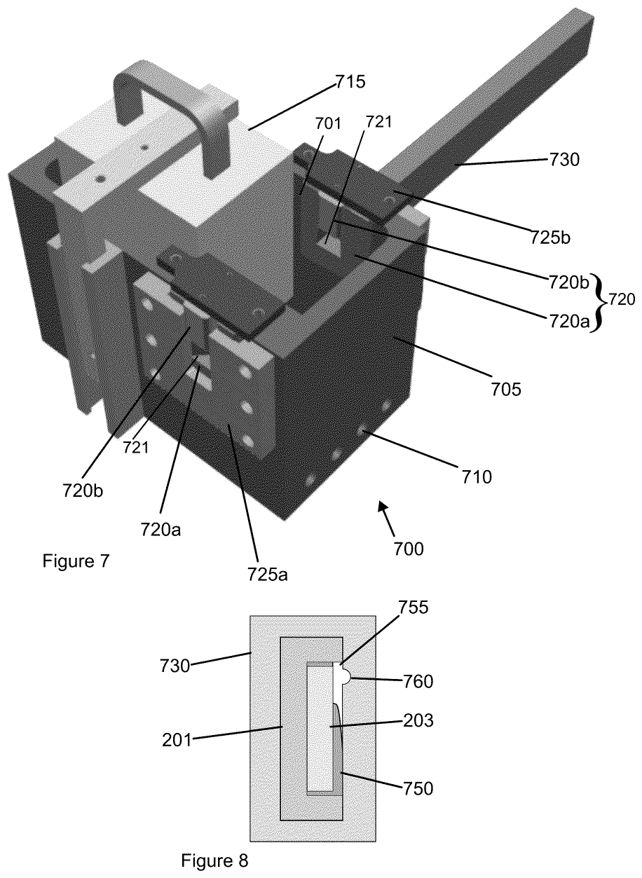

FIG. 7 illustrates a bath 700 which may be used in consolidating an HTS cable or, conveniently, used as a tape consolidation device 540 described above. The bath can be used to submerge a length of a cable comprising HTS tapes (e.g. a stack of HTS tapes 203 located within an open channel 201) within a consolidating material. The bath is moveable relative to the cable to progressively submerge and consolidate the cable or a coil wound from the cable. Relative motion of the cable and the bath may be achieved by moving the cable through the bath or moving the bath over the cable (e.g. if the bath is carried by a fixing carriage 535) or a combined motion of the two. The consolidating material may be a solder or other suitable consolidating material such as an electrically conductive resin.

For ease of illustration, a bath 700 suitable for containing a solder and for use as a tape consolidation device 540 is described below. It will be appreciated that modifications may be made to this illustrated embodiment, such as the choice of construction materials, for use with other consolidating materials or other HTS cables.

The solder bath 700 comprises a container 705 for the solder. The container may be made from a metal such as stainless steel, aluminium, or some other material suitable for containing molten solder. The container 705 may have a protective, solder-resistant layer on the inside and a thermally insulating layer on the outside. A base of the container may be provided with one or more holes 710 for inserting one or more respective cartridge heaters or similar heating elements for use in heating the solder, in which case the body of the container 705 may have a high thermal conductivity. The heating elements may be automatically controlled in response to readings from a temperature sensor. Other means for heating the solder may be used. The container 705 may be on the order of 10 cm to 20 cm in each dimension to be easily movable while still having sufficient internal volume to contain enough solder not to need continuous refilling.

A displacer 715 is movable into and out of the container 705 to displace and therefore change the level of the solder within the container 705. As solder is depleted in use of the bath 700, the displacer 715 may be gradually lowered into the container 705 to ensure the channel 201 remains submerged in solder. The displacer 715 may be made from a material having a low thermal expansion coefficient, and have a low thermal conductivity and specific heat capacity to minimise heat loss from the solder into and through the displacer 715 and to reduce the effects of introducing the displacer into the solder. Materials such as silicone or other heat resistant rubbers or polymers may be suitable. An additional heat resistant layer may be provided on at least the surfaces of the displacer 715 exposed to solder to protect it and extend its working life. The heat resistant layer may be a fluoropolymer, e.g. polytetrafluoroethylene (PTFE) or similar. Alternatively, or in addition, the displacer may be pre-heated before being introduced into the solder.

An opening 701 (e.g. a notch or slit) is provided on each of two opposing sides of the container 705. Each of the openings is provided with a seal 720 within the opening, and each seal has an opening (hereafter referred to as an “aperture”) 721 which passes through the seal. In use, the superconducting cable 300 passes through these apertures such that the full width of the cable or at least the groove 202 and the HTS tapes 203 within it are below the top of the container 705 and can be submerged in solder.

Each seal 720 may be formed from a flexible, compressible, resilient material having an aperture 721 sized and shaped to receive and fit tightly around the superconducting cable 200 to prevent leakage of solder past the superconducting cable 200 out of the container 705. Each seal surrounds the channel to apply pressure from all directions. This retains the solder within the channel and forces out excess solder and/or flux fumes such that the solder can penetrate all spaces between HTS tapes to effectively consolidate the cable. Flexibility in the seals 720 enables them to adapt to changing curvature along the superconducting cable 200 while still maintaining a tight seal. The maximum bend radius of the superconducting cable 200 that the solder bath 700 can tolerate will also depend upon the distance between the apertures 721. The interior of the container 705 may therefore be smaller in a length direction (i.e. the direction of travel of the cable) compared to its height and width (i.e. the horizontal direction perpendicular to the length) to reduce the distance between the apertures 721 while still having a desired internal volume. Compressible, resilient seals 720 will also conform to small variations in the shape or size of the outer envelope of the superconducting cable 200 along its length to ensure that the solder is retained in the groove 202 and other empty spaces and does not protrude outside the envelope of the superconducting cable 200.

Suitable materials for the seals 720 include silicone or other heat resistant rubbers, elastomers, or polymers. For example, cured silicone rubbers having a Shore A hardness of from 25 to 60 and/or thermally stable up to 250° C. may be suitable for creating a seal around a superconducting cable 200 as described above.

As shown in FIG. 7, the openings may be provided as slits in the top edge of the container 705 for receiving the seals 720 and superconducting cable 200. This simplifies initial insertion of the seals 720 and superconducting cable 200, and subsequent removal at the end of processing or to replace degraded seals 720. Each seal 720 may include a separate base portion 720a and a cap portion 720b, which together define the aperture 721 (i.e. the aperture extends between the base portion and the cap portion). The base portion 720a of a seal 720 can be inserted into the opening, then the superconducting cable 200 is initially introduced into the container 705 by lowering it vertically into the base portion 720a, and then the full seal is completed by adding the cap portion 720b. The seals 720 are held in place with clamps 725 such as a side clamp 725a for securing the seal base portion 720a against the side of the container 705 and/or a top clamp 725b for securing and holding down the seal top portion 720b.

Alternatively, the openings may be provided as enclosed holes through the side walls of the container 705 and/or each seal 720 may be a single sealing member having an aperture 721 within it. The superconducting cable 200 may then be initially introduced into the container 705 by inserting it through the aperture 721 in the seal lengthways.

In operation, the following steps may be performed to prepare the bath 700 and cable 200 (or coil 300) for the consolidation process:
(a) Fill the container 705 with solder to below the level of the seal 720 and warm it to 210° C.
(b) Introduce the cable 200 into bath 700 by lowering it into the seal base portions 720a located within slits in the top of the container 705.
(c) Place the seal cap portions 7250b over the cable 200 and secure each with a top clamp 725b.
(d) Lower the displacer 715 to raise the solder level and submerge the cable 200.

As the superconducting cable 200 exits the solder bath 700, the liquid solder that has filled the groove 202 and impregnated the stack of HTS tapes 203 should be allowed to solidify sufficiently that it remains in place.

Directing a flow of coolant, such as room temperature or cooled air, at the superconducting cable 200 as it exits the solder bath 700 can quickly cool and solidify the solder 750 and ensure it remains in the groove 202. Alternatively, or in addition, the exit to the solder bath 700 can be provided with an elongated (e.g. on the order of 10 cm to 30 cm) sleeve 730 of a flexible and resilient material. Materials suitable for the seals 725, as described above, may also be suitable for the sleeve 730, and at least the interior surfaces of the sleeve 730 may be provided with a protective and low-friction coating or layer. As such, the sleeve 730 may be a continuation or extension of the exit seal 720 or be a separate piece connected to the exit seal 720 by, for example, clamps 725. The sleeve 730 fits tightly around the superconducting cable 200, having internal dimensions equal to or slightly less than the dimensions of the superconducting cable 200, to retain the solder in place as it cools. Sleeves 730 may be provided on both seals 720 if the solder bath 700 is required to move in both directions relative to the cable 300.

Where the cable 300 is bent, the sleeve 730 may have a resting position which is bent to a similar radius of curvature to the cable 300 and/or may be sufficiently flexible to conform to the radius of curvature of the cable 300 or to changes in the radius of curvature or axis of bending. Where the cable 300 is straight, the sleeve will only require sufficient flexibility to conform around the cross-section of the cable 300.

The sleeve 730 may be openable, i.e. able to be opened along its length such that the superconducting cable can be initially inserted into the sleeve through the side wall of the sleeve, and able to be resealed such that the sleeve sealingly conforms around the superconducting cable.

Where an alternative consolidating material is used, such as a conductive resin, solidifying the consolidating material may require a curing process such as UV exposure, and means for achieving this curing process e.g. a source of UV light may be provided where the superconducting cable 200 exits the solder bath 700.

The seals 720 and/or sleeve 730, or at least internal surfaces of the seals and/or sleeve that contact solder and/or the superconducting cable 200, may be provided with one or more additional layers or coatings such as protective, heat resistant and/or low friction coatings or layers. Even rubbers usually marketed as “heat resistant” may become brittle under repeated exposure to molten solder (at temperatures in excess of 200° C.) and/or may suffer from degradation due to chemical reaction with the solder. A comparatively heat resistant layer and/or a protective layer providing a physical barrier can therefore extend the working life of the seals 720 and/or sleeve 730. The seal and/or sleeve may provide a very tight fit around the superconducting cable 200 requiring a large amount of force to pass the superconducting cable 200 through the seals 720 and/or sleeve 730.

The forces required to pass the cable 200 through the seals 720 and/or sleeve 730 may be reduced by providing a friction-reducing lining, i.e. an internal layer having a coefficient of friction (COF) between the material of the layer and the material of the channel which is lower than the COF between the material forming the body of the seal 720 or sleeve 730 and the material of the channel. The relative coefficients of friction can be measured empirically by comparing the force required to pull the cable through the seal or sleeve with and without the layer having a lower coefficient of friction-if the layer lowers the coefficient of friction, as required, then it will be easier to pull the cable through with the layer present than with the layer absent. Fluoropolymers such as polytetrafluoroethylene (PTFE) are one class of suitable material that can protect the body of the seal and/or sleeve from heat and direct contact and have very low COFs with most materials.

The material of the additional layer(s) may not be as flexible or compressible as the material forming the body of the seal 720. PTFE, for example, is relatively inflexible and incompressible compared to, e.g., silicone rubber. The layer should be sufficiently thin that the seal can flex with and conform to the shape of the superconducting cable 200. As an example, for PTFE, a thickness of less than 1 mm, or from around 0.1 mm to 0.2 mm may be suitable. As a further example the thickness of the additional layer may be less than 10% of the thickness of the material forming the body of the seal 720 or sheath 730, or less than 5% of the thickness, or less than 1% of the thickness.

While the above description refers to a superconducting cable 200 as previously described, the consolidation method and the solder bath may be used with any type of superconducting cable, and is particularly suited to superconducting cables comprising a plurality of HTS tapes.

FIG. 8 is a schematic cross-section through an HTS cable 200 within a sleeve 730 illustrating non-optimal solder consolidation. The solder 750 has sunk under gravity into a lower region of the groove 202 in the channel 201, leaving a void or air gap 755 in an upper region of the groove 202.

The length of the sleeve 730 required to ensure acceptable consolidation will depend upon factors including the temperature of the solder and the local environment, and the speed of travel of the solder bath 700 around the coil 300. Accelerated cooling of solder 750 within a sleeve 730 may be achieved by providing a cooling channel, for carrying a suitable coolant in use, encircling the sleeve 730 one or more times and located either within the body of the sleeve or around its outer perimeter.

Another solution to improving consolidation is to increase the pressure forcing solder 750 into the groove 202. This may be done simply by providing a greater head of solder above the superconducting cable 200 within the bath 700. Another option is to seal the container 705 of the solder bath 700 and pressurise it, though this may present unacceptable risks without pressure regulators and/or safety valves. Another solution is to provide an internal channel or groove 760 along the sleeve 730, coincident with the top of the groove 202 in the conductive channel 201, to enable fresh solder 750 to flow from the container 705 into the groove 202 if a void 755 forms.

An alternative approach to consolidating a superconducting cable uses a flexible sleeve similar to the flexible sleeve 730 described above. This approach may be used for rigid cables, e.g. cables comprising a substantially rigid substrate such as superconducting cable 200, but is particularly suitable for flexible cables. For example, a flexible cable may be formed from a stack of tapes comprising a plurality of HTS tapes and optionally one or more other tapes or flexible layers that may be adjacent to, interleaved with and/or sandwich around the stack of HTS tapes.

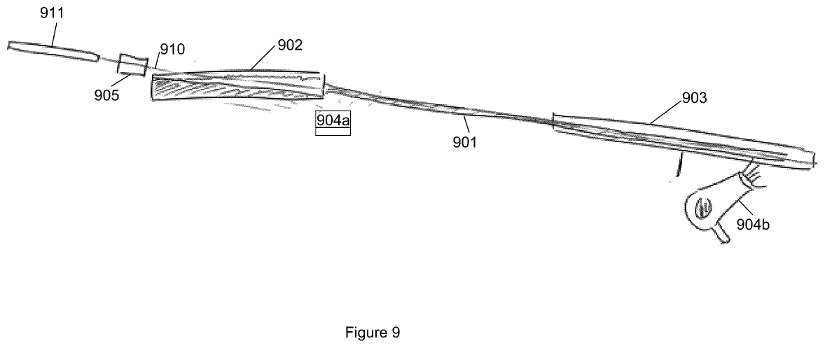

The apparatus for this approach is illustrated schematically in FIG. 9. The apparatus comprises a flexible sleeve 901 which is resilient to conform to a superconducting cable 910, and a liquid consolidating material supply 902 arranged to provide liquid consolidating material to the superconducting cable as it enters the flexible sleeve or before it enters the flexible sleeve. The apparatus may optionally comprise means for moving the superconducting cable relative to the flexible sleeve (otherwise it may be moved manually), such as a mandrel 903 which winds the superconducting cable into a coil and progressively pulls it in. The apparatus may further optionally comprise components to assemble the superconducting cable in-situ, e.g. spools 911 of HTS tape and optionally other tapes which are brought together to progressively form the superconducting cable prior to the cable entering the flexible sleeve. The apparatus may further optionally comprise heating 904a and/or cooling 904b located along the flexible sleeve, with the cooling preferably located towards an end opposite the liquid consolidating material supply.

The liquid consolidating material supply may comprise a bath of liquid consolidating material which the superconducting cable (or components of the superconducting cable) pass through prior to entering the flexible sleeve. Alternatively, the liquid consolidating material supply may comprise a reservoir of liquid consolidating material and a conduit which provides liquid consolidating material from the reservoir to the entrance of the flexible sleeve 901.

The consolidating material may be a solder. Other components such as a flux applicator 905 may be provided to aid in incorporating the consolidating material into the superconducting cable.

The solder will be liquid along a first portion of the sleeve close to the liquid consolidating material supply, and solid along a second portion of the sleeve. The sleeve may be inclined downwards so that gravity helps keep liquid solder in place. The flexible cable may be bent into the desired final shape while it is within the first portion of sleeve and the solder is liquid, e.g. by the mandrel shown in FIG. 9, or by other suitable tooling. In this way, the solder solidifies in the desired cable shape without placing strain on the HTS tapes at the outside of the bend. The cable then exits the sleeve in the bent shape. The relative lengths of the first and second portions can be controlled by positioning sources of heating and/or cooling along the sleeve. For example the sleeve and cable can be heated until passing through a bending station and cooled after bending or at or near the exit of sleeve.

The bent cable can be wound onto a former on a rotating table to form a magnet. Alternatively, the cable forming and bending apparatus can move around a fixed table.

Additional embodiments of the invention are further indicated in the following numbered clauses.

Clause 1. A method for manufacturing a superconducting magnet comprising:
providing an electrically conductive substrate shaped into a substantially planar coil having a plurality of turns, the electrically conductive substrate having a groove along its length, the groove facing a radial direction of the coil;
translating at least a portion of the electrically conductive substrate out of the plane of the coil to expose at least a portion of the groove; and
inserting superconducting material into the exposed portion of the groove.

Clause 2. The method of Clause 1 wherein the electrically conductive substrate is an open channel.

Clause 3. The method of Clause 1 wherein the groove faces inwardly in a radial direction of the coil.

Clause 4. The method of Clause 1 wherein the superconducting material comprises a plurality of tapes of high temperature superconducting material.

Clause 5. The method of Clause 1 wherein the translating step comprises progressively, along the length of the electrically conductive substrate, translating a portion of the electrically conductive substrate out of the plane of the coil to progressively expose a portion of the groove.

Clause 6. The method of Clause 1 further comprising the step of consolidating the superconducting material in into the groove with an electrically conductive consolidating material.

Clause 7. The method of Clause 6 wherein consolidating comprises filling the exposed portion of the groove with the consolidating material as a liquid and allowing the liquid to solidify.

Clause 8. The method of Clause 7 wherein filling comprises submerging at least the superconducting material in the exposed portion of the groove in the consolidating material as a liquid.

Clause 9. The method of Clause 8 wherein submerging comprises moving a bath of liquid consolidating material along the length of the electrically conductive substrate to progressively submerge at least the superconducting material in the groove in the consolidating material.

Clause 10. The method of Clause 1 wherein providing an electrically conductive substrate shaped into a substantially planar coil comprises bending the electrically conductive substrate into a substantially planar coil.

Clause 11. A method for manufacturing a superconducting magnet comprising:
providing an electrically conductive substrate shaped into a substantially planar coil having a plurality of turns, the electrically conductive substrate having a groove along its length, the groove facing a radial direction of the coil, superconducting material being located within the groove;
translating at least a portion of the electrically conductive substrate out of the plane of the coil to expose at least a portion of the groove; and
consolidating the superconducting material located in the exposed portion of the groove with an electrically conductive consolidating material.

Clause 12. A device for manufacturing a superconducting magnet comprising:
a substantially planar coil having a plurality of turns formed from an electrically conductive substrate, the electrically conductive substrate having a groove along its length, the groove facing a radial direction of the coil;
a first carriage movable relative to the coil and for translating at least a portion of the electrically conductive substrate out of the plane of the coil to expose at least a portion of the groove;
and at least one of:
a second carriage movable relative to the coil and for inserting superconducting material into the exposed portion of the groove; and/or
a third carriage movable relative to the coil and for consolidating superconducting material located in the exposed portion of the groove.

Clause 13. The device of Clause 12 wherein the first carriage is movable around the coil to progressively translate the length of the electrically conductive substrate out of the plane of the coil.

Clause 14. A method for manufacturing a superconducting magnet comprising:
providing a substrate shaped into a spiral coil having a plurality of turns, each turn being larger in a radial direction of the coil than a preceding turn;
translating at least a portion of the substrate in a direction substantially perpendicular to said radial direction to make the portion of the substrate accessible for a subsequent operation;
at the accessible portion of the substrate, performing one or both of the following subsequent operations:
   applying superconducting material to the substrate; and
   fixing superconducting material to the substrate.

Clause 15. The method of Clause 14 wherein the substrate is electrically conductive.

Clause 16. The method of Clause 14 wherein the substrate comprises an open channel having a groove oriented in said radial direction.

Clause 17. The method of Clause 14 wherein performing the subsequent operation comprises progressively performing the subsequent operation around the coil.

Clause 18. The method of Clause 14 wherein applying superconducting material to the substrate comprises laying a stack of HTS tapes against or into the substrate.

Clause 19. The method of Clause 14 wherein fixing superconducting material to the substrate comprises fixing the superconducting material to the substrate with an electrically conductive material.

Clause 20. A device for manufacturing a superconducting magnet comprising:
a support configured to hold a coil having a plurality of turns formed from an electrically conductive substrate;
one or more first carriages movable relative to the support and for translating at least a portion of the electrically conductive substrate away from the support to expose at least a portion of a radially inward facing or radially outward facing surface of the substrate; and
at least one of:
a second carriage movable relative to the support and for applying superconducting material to the exposed radially inward facing or radially outward facing surface of the substrate; and/or
a third carriage movable relative to the support and for consolidating superconducting material located on the exposed radially inward facing or radially outward facing surface of the substrate.

[Clauses 21-25 deliberately omitted]

Clause 26. A method of consolidating a superconducting cable, the method comprising:
providing a sleeve, wherein the sleeve is a flexible, resilient sleeve having an internal surface which conforms to the superconducting cable;
passing the superconducting cable through the sleeve;
providing consolidating material as a liquid to the superconducting cable as the superconducting cable enters the sleeve or prior to the superconducting cable entering the sleeve;
wherein the superconducting cable passes through the sleeve at a rate such that the consolidating material is substantially solid where the superconducting cable exits the sleeve.

Clause 27. The method of clause 26 wherein the sleeve is connected to an aperture in a side of a bath containing consolidating material as a liquid and providing consolidating material as a liquid to the superconducting cable comprises submerging the superconducting cable at least partially in the consolidating material within the bath and passing the superconducting cable through the bath such that it exits the bath through the aperture into the sleeve.

Clause 28. The method of clause 26 further comprising bending the superconducting cable as it passes through the sleeve before the consolidating material has solidified.

Clause 29. The method of clause 26, and comprising cooling the sleeve.

Clause 30. Apparatus for consolidating a superconducting cable, the apparatus comprising:
a sleeve, wherein the sleeve is flexible and resilient to conform to the superconducting cable, the sleeve having a first end and a second end;
a liquid consolidating material supply located at the first end of the sleeve and configured to supply consolidating material as a liquid to the superconducting cable.

Clause 31. The apparatus of clause 30, further comprising a groove in an internal wall of the sleeve, the groove providing a passage for the flow of consolidating material as a liquid from the liquid consolidating material supply along the superconducting cable within the sleeve.

Clause 32. The apparatus of clause 30, wherein the sleeve comprises a friction reducing lining on an inner surface.

Clause 33. The apparatus of clause 32, wherein the friction reducing lining comprises a fluoropolymer.

Clause 34. The apparatus of clause 30, further comprising a moving unit configured to move the superconducting cable relative to the sleeve such that the superconducting cable travels relative to the sleeve in a direction from the first end of the sleeve to the second end of the sleeve.

Clause 35. The apparatus of clause 30, and comprising a cooler configured to cool the sleeve.

Clause 36. The apparatus of clause 35, wherein the cooler is located closer to the second end of the sleeve than the first end.

Clause 37. The apparatus of clause 30, and comprising a bending tool located between the first end of the sleeve and the second end of the sleeve, and configured to bend the sleeve and the superconducting cable.

Clause 38. The apparatus of clause 37, and comprising a heater configured to heat the sleeve between the first end of the sleeve and the bending tool.

1. A bath for consolidating a superconducting cable, the bath comprising:
a container having first and second openings in respective sides of the container, the first opening being located on an opposite side of the container to the second opening;
first and second seals positioned respectively within the first and second openings, the first and second seals each having an aperture through the respective seal and each seal being flexible and resilient to conform to the superconducting cable when the superconducting cable passes though the respective aperture;
wherein the container is configured to contain an amount of a consolidating material as a liquid that at least partially submerges a superconducting cable passing through both apertures.

2. The bath of claim 1 further comprising an elongate sleeve extending from the aperture of the second seal, the sleeve formed from a flexible and resilient material for sealing around the superconducting cable.

3. The bath of claim 2 further comprises means for cooling the sleeve.

4. The bath of claim 2 further comprising a groove in an internal wall of the sleeve, the groove providing a passage for the flow of consolidating material as a liquid from the container along the superconducting cable within the sleeve.

5. The bath of claim 2, wherein the sleeve and/or the seal comprises a friction-reducing lining on an inner surface.

6. The bath of claim 1 further comprising a displacer movable relative to the container to displace varying amounts of the consolidating material as a liquid and thereby raise and lower a level of the consolidating material.

7. The bath of claim 6, wherein the displacer is formed from silicone or a rubber.

8. The bath of claim 6, and comprising means for heating the displacer.

9. The bath of claim 1, and comprising means to heat the container.

10. The bath of claim 1, wherein a length of the interior of the container between the first aperture and the second aperture is less than a width of the container in a horizontal direction perpendicular to the length.

11. The bath of claim 1 wherein each opening extends to a top edge of the respective side of container.

12. The bath of claim 1, wherein each seal comprises a base portion and a cap portion, with the aperture extending between the base portion and the cap portion, wherein at least the cap portion is removable from the opening.

13. The bath of claim 1, and comprising one or more clamps arranged to secure the seal against the container.

14. The bath of claim 1, wherein the container is sealable, and comprising means to pressurise the container.

15. A method of consolidating a superconducting cable, the method comprising:
providing a container having first and second seals in different sides of the container, the first and second seals each having an aperture through the respective seal, and each seal being flexible and resilient to conform to the superconducting cable when the superconducting cable passes through the aperture;
inserting a portion of the superconducting cable into the container such that the superconducting cable passes through the first and second apertures;
providing a consolidating material as a liquid within the container at a level which at least partially submerges the portion of the superconducting cable;
moving the superconducting cable and the container relative to each other to pass the superconducting cable through the apertures and thereby at least partially submerge progressive portions of the superconducting cable in the consolidating material as a liquid;
allowing the consolidating material to solidify within the superconducting cable to consolidate the superconducting cable.

16. The method of claim 15, and comprising heating the container to a temperature above a melting point of the consolidating material.

17. The method of claim 15, and comprising flowing a coolant over the superconducting cable as it exits the container.

18. The method of claim 15, and comprising pressurising the container following insertion of the superconducting cable.

19. The method of claim 15, wherein each seal comprises a base portion and a cap portion, wherein each aperture extends between the respective base portion and the respective cap portion when both the base portion and the cap portion are inserted into the respective side of the container, and wherein inserting a portion of the superconducting cable into the container comprises:
with the base portion of each seal inserted into the respective side of the container, inserting the superconducting cable into contact with each base portion;
inserting the cap portion of each seal into the respective side of the container, thereby forming each aperture around the superconducting cable.

20. The method of claim 15, wherein the superconducting cable comprises a stack of high temperature superconducting, HTS, tapes and the step of at least partially submerging progressive portions of the superconducting cable in the consolidating material comprises filling spaces between the HTS tapes with consolidating material.

21. The method of claim 20, wherein the superconducting cable further comprises a substrate and wherein the consolidating material fixes the stack of HTS tapes to the substrate when solidified.

22. The method of claim 21, wherein the substrate is substantially rigid and electrically conductive.

23. The method of claim 15, wherein the consolidating material is electrically conductive when solid.

24. The method of claim 15, wherein the consolidating material comprises a solder.

25. The method of claim 15, wherein the step of providing a consolidating material as a liquid within the container at a level which at least partially submerges the portion of the superconducting cable comprises:
prior to inserting the superconducting cable, providing the consolidating material within the container at a level below the apertures;
following insertion of the superconducting cable, partially submerging a displacer into the consolidating material in order to raise the level of the consolidating material such that it at least partially submerges the portion of the superconducting cable.
